(19) United States
(12) Patent Application Publication
(10) Pub. No.: US 2016/0349729 A1
(43) Pub. Date: Dec. 1, 2016

(54) METHOD FOR MACHINING A COMPONENT ON A MULTI-AXIS MACHINE TOOL DRIVEN BY AN NC-CONTROLLER AND APPARATUS FOR CONDUCTING SAID METHOD

(71) Applicant: ANSALDO ENERGIA IP UK LIMITED, London (GB)

(72) Inventors: Hartmut FENKL, Kreuzlingen (CH); Hartmut HÃHNLE, Kussaberg (DE)

(73) Assignee: ANSALDO ENERGIA IP UK LIMITED, London (GB)

(21) Appl. No.: 15/163,252

(22) Filed: May 24, 2016

(30) Foreign Application Priority Data
May 27, 2015 (EP) 15169448.6

(51) Int. Cl. G05B 19/31; B23Q 17/24

(52) U.S. Cl. CPC G05B 19/31; B23Q 17/2471; B33Y 10/00

(57) ABSTRACT

A method for machining a component on a machine tool includes the steps of: a) inserting the component into the machine tool; b) fixing the component in said machine tool with a surface to be machined being reachable by a tool of the machine tool; c) mapping the material composition on the surface of the inserted and fixed component via a spectroscopy tool; d) determine areas for removing material from or adding material to the component having regard to the mapped material composition; e) determine a tool path for removing material from or adding material to the component; and f) removing material from or adding material to the component in the determined areas along the determined tool path via machine tool.

### BACKGROUND OF THE INVENTION

The present invention relates to the process of machining a component. It refers to a method for machining a component on a multi-axis machine tool driven by an NC-controller.

It further refers to an apparatus for conducting such method.

### PRIOR ART

The machining of e.g. turbine blades (e.g. during reconditioning, but also for preparation of subsequent manufacturing steps) is today done with either information on nominal geometry (->standard machining) or information on nominal and actual geometry (->adaptive machining).

For parts or components that are produced from graded material or from different material layers (e.g. base material plus one or more coating layers), the detection of the surface material (material composition/chemical elements) is today often done visually, sometimes also in an analysis step requiring specific equipment with either destructive or non-destructive methods.

The information on the actual layer material composition however can be essential to control material removal (e.g. by milling, grinding, EDM, laser ablation, or the like) and/or material addition (e.g. by laser cladding, selective laser melting, or the like).

State of the art adaptive machining processes make use of geometrical information (nominal and measured) to create a tool path for the machining tool. This is done with commercially available software packages (e.g. from DELCAM).

Adaptive machining is described in various documents.

For example, document U.S. Pat. No. 8,578,579 B2 discloses a method of repair including removing a deformed portion of a component to define a native component portion and adding a replacement portion to the native component portion. The replacement portion is adaptively machined based on one or more parameters of the native component portion and based on one or more original design parameters of the component.

Document U.S. Pat. No. 8,442,665 B2 discloses a system including a three-dimensional object having a non-conforming region, and a photogrammetry device adapted to scan the three-dimensional object. The system further includes optical reference targets and a controller structured to perform functions of repairing the three-dimensional object. The controller commands the photogrammetry device to scan the three-dimensional object, and calculates a nominal surface location and contour for the three-dimensional object. The controller further commands the photogrammetry device to scan the non-conforming region of the three-dimensional object, and calculates a material removal tool path comprising a path adapted to remove material from the object located beyond the nominal surface location and contour. The controller generates a solid model of the damaged region of the object based on the nominal surface location and contour, and computes a material addition tool path according to the solid model.

Document US 2011276166 A1 discloses a method and system for modifying a substrate, such a thin film, solar panel or the like detects error and/or variance and, if needed, re-optimizes the product design and/or process parameters on the fly, so that product can meet the product specification. This allows for methods and systems of process control that can adaptively change the product design in real time.

Document US 2013158698 A1 relates to a fabrication processing system of CIGS thin film solar cell, more particularly to a fabrication processing system CIGS of thin film solar cell equipped with real-time analysis facilities for profiling the elemental components of CIGS thin film using laser-induced breakdown spectroscopy. The system is to provide a process control system for determining whether abnormalities are present or not by measuring physical and chemical properties on continuous production process lines of CIGS thin film solar cell in real time, and performing a production and quality management at the same time by providing a feedback to CIGS fabrication process.

However, it would be highly advantageous to include information about the (varying) local material compositions of a component to be machined in the machining process in order to optimize removal and/or deposit of material in certain surface areas of said component.

One means of detecting material composition is spectroscopy.

However, such spectrometers are today not provided for use inside a machine tool.

In general, the information on chemical composition (measured with a spectrometer) is today not used for adaptive manufacturing processes.

### SUMMARY OF THE INVENTION

It is an object of the present invention to integrate a spectroscopy device into the machining process on a multi-axis machine tool driven by an NC-controller.

It is another object of the present invention to provide a material data capture and analysis process and its feed-back into an adaptive tool path generation.

These and other objects are obtained by a method according to claim 1 and an apparatus according to claim 12.

According to the invention a method for machining a component on a multi-axis machine tool driven by an NC-controller comprises the steps of:
a) inserting said component into said machine tool;
b) fixing said component in said machine tool with a surface to be machined being reachable by a tool of said machine tool;
c) mapping the material composition on said surface of said inserted and fixed component by means of a spectroscopy tool;
d) determine areas for removing material from or adding material to said component having regard to said mapped material composition;
e) determine a tool path for removing material from or adding material to said component; and
f) removing material from or adding material to said component in said determined areas along said determined tool path by means of said machine tool.

An embodiment of the inventive method is characterized in that a raster with a plurality of defined or arbitrary raster points is provided for said surface of said component to be machined, and that said material composition of said component is mapped at said raster points of said raster.

Another embodiment of the inventive method is characterized in that said step of removing material from said component comprises one of grinding, milling, Electrical Discharge Machining (EDM), or other material-removing process.

A further embodiment of the inventive method is characterized in that said step of adding material to said component comprises Laser Metal Forming (LMF), or other material-additive process.

Especially, said raster with said plurality of raster points is defined on the basis of a CAD model of said component.

Alternatively, said raster with said plurality of raster points is based on a scan of the geometry of said component.

Just another embodiment of the inventive method is characterized in that steps (c) to (f) are rerun at least one time with the same or a different tool.

A further embodiment of the inventive method is characterized in that said component is a part of a gas turbine.

Especially, said component is a turbine blade.

Another embodiment of the inventive method is characterized in that said said spectroscopy tool is mounted in a fixed position inside said machine tool.

Alternatively, said machine tool is equipped with a tool changer, and that said spectroscopy tool is provided in said tool changer of said machine tool.

The apparatus according to the invention for conducting the inventive method comprises a multi-axis machine tool driven by an NC-controller with tools for removing material from or adding material to a component inserted into and fixed in said machine tool. It is characterized in that a spectroscopy tool is provided at said machine tool for mapping the material composition on a surface of said inserted and fixed component.

An embodiment of the apparatus according to the invention is characterized in that said spectroscopy tool is mounted in a fixed position inside said machine tool.

Alternatively, said machine tool is equipped with a tool changer, and said spectroscopy tool is provided in said tool changer of said machine tool.

### BRIEF DESCRIPTION OF THE DRAWINGS

The present invention is now to be explained more closely by means of different embodiments and with reference to the attached drawings.

FIG. 1 shows, in a flow chart, various steps of a machining process according to an embodiment of the invention;

FIG. 2 shows a turbine blade with a surface raster as an exemplary component to be machined by the inventive machining process;

FIG. 3a-d shows various states of the turbine blade of FIG. 2 during a machining process according to an embodiment of the invention; and

FIG. 4 shows an embodiment of an apparatus with spectroscopic capabilities according to the invention.

### DETAILED DESCRIPTION OF DIFFERENT EMBODIMENTS OF THE INVENTION

The present invention uses material identification inside a machine tool in an adaptive manufacturing process.

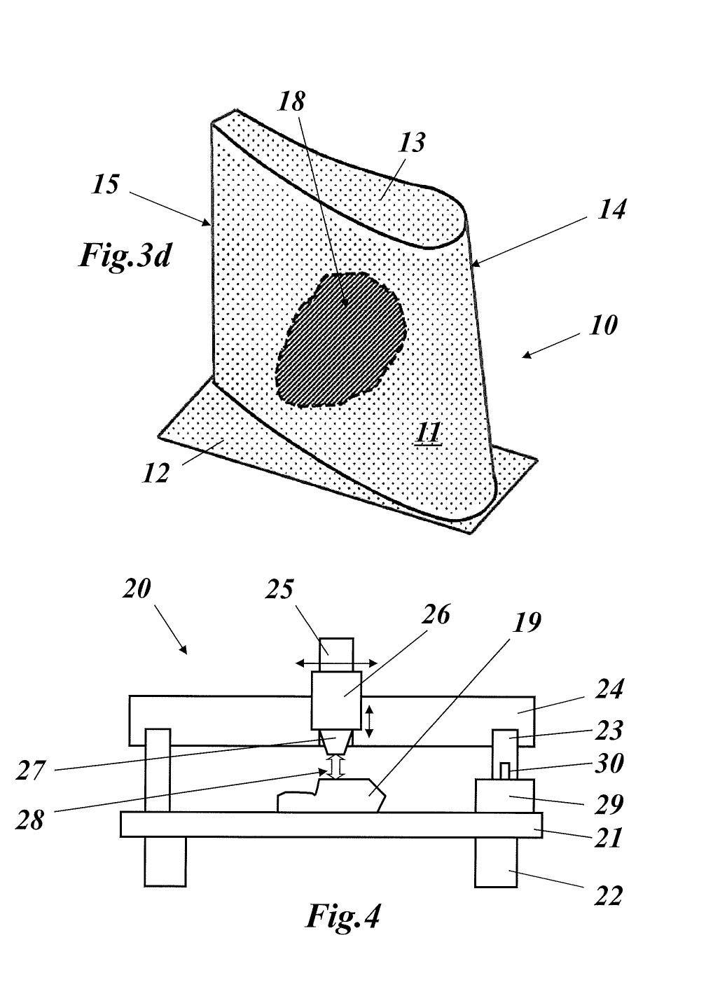

As shown in FIG. 4, a spectroscopy tool (or device) 27 is implemented as an aggregate into a multi-axis machine tool 20 driven by an NC-controller, wherein a component 19 to be machined is inserted and fixed on a table 21. Table 21 is supported by mounting feet 22. A tool holder 26 is movable in vertical direction on a vertical carriage 25, which carriage 25 can be moved in a first horizontal direction along a cross beam 24. Cross beam 24 can be moved in a second horizontal direction on rails 23. Additional axes of rotation may be provided. Machine tool 20 is further equipped with a tool changer 29 containing various machining tools 30.

FIG. 4 further shows a spectroscopy tool 27 held by tool holder 26 in order to determine the material composition on a surface of component 19 by means of a spectroscopy beam 28. This configuration enables an adaptive manufacturing process, wherein material interfaces or material composition may be detected and this information is used for defining the machining process and/or tool path.

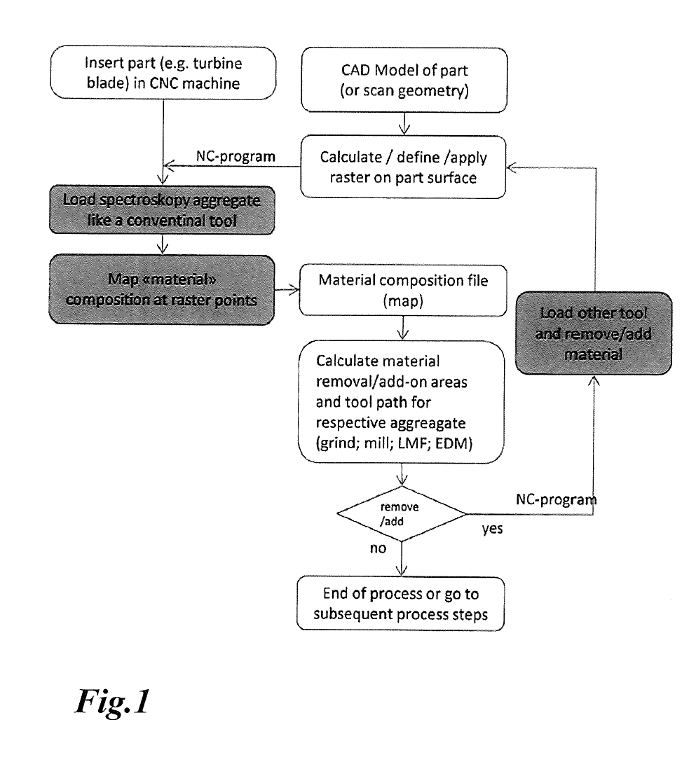

With such a configuration a machining process can be realized in accordance with FIG. 1:

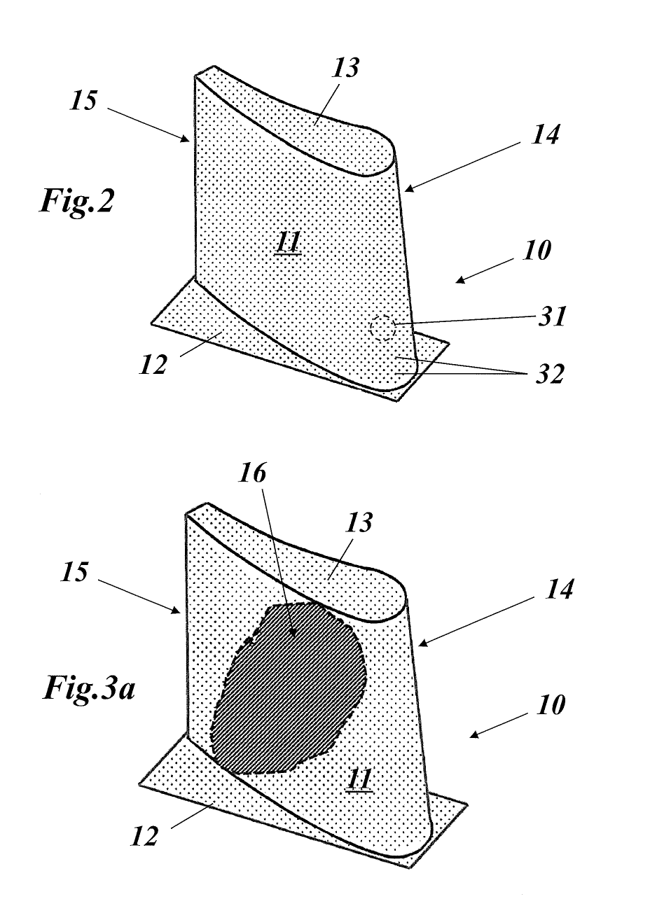

First of all, the part or component 19 to be machined (e.g. a turbine blade 10 as shown in FIG. 2) is inserted into the machine tool 20 (here named “CNC machine”) and fixed on table 21 or an equivalent fixture. Turbine blade 10 of FIG. 2 comprises an airfoil 11 with a leading edge 14 and a trailing edge 15. At one end, airfoil 11 ends with a blade tip 13, while a platform 12 is provided at the other end.

In a next step, a spectroscopy tool 27 is used for spectroscopic inspection of the surface of the component 19. The spectroscopy tool is either fixedly mounted on said machine tool 20 or is fetched like a conventional tool from tool changer 29 by tool holder 26. Spectroscopy tool 27 may communicate with the machine control of machine tool 20 either wireless or by wire to transfer the collected material composition data to the central computer system.

Then, the material composition of a surface of component 19 is mapped by means of said spectroscopy tool 27 at certain raster points (32 in FIG. 2) of a raster 31 (FIG. 2). This raster 31 is calculated by the computer system on basis of either a CAD model of component 19 or a geometry scan of said part.

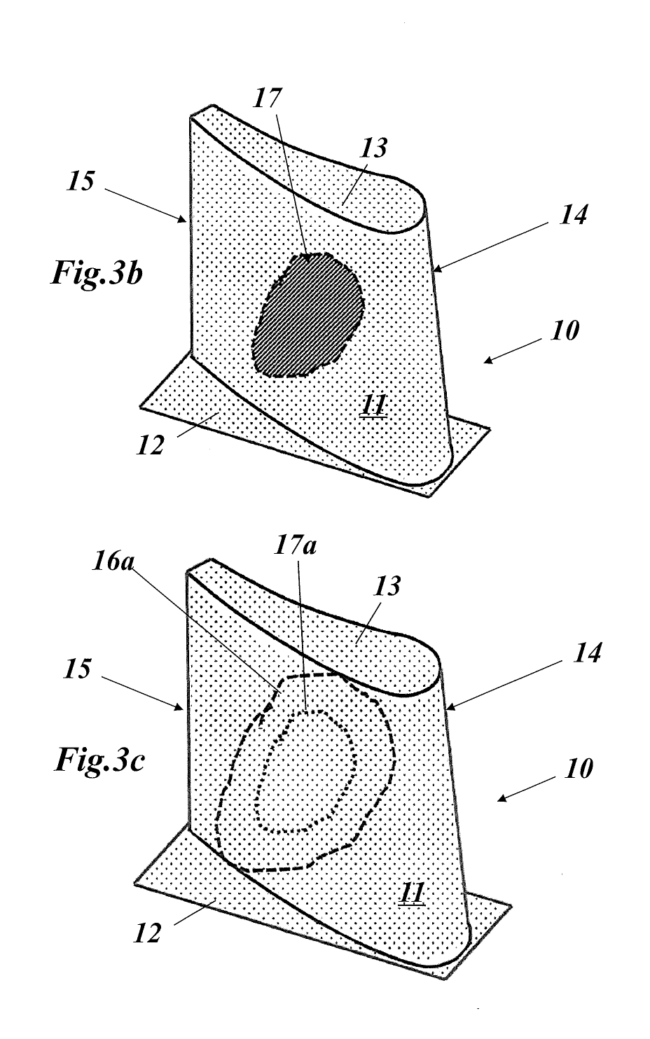

The result of the mapping process is shown in FIG. 3a, where an area 16 is identified and calculated, which contains a material being different from the material outside said area. For example, area 16 may contain a coating layer or a depleted base layer, which must be removed by the subsequent machining process, while the surface outside area 16 contain base material, which doesn't require any removal.

In a next step, material is removed in area 16 by a first material-removing process or step like grinding or milling or Electrical Discharge Machining (EDM), whereby a tool-specific path for the material-removing tool used has been calculated on basis of the identified area 16.

FIG. 3b shows the turbine blade 10 after this first material-removing step, wherein a smaller area 17 of material to be removed remains.

In a next step, the material in area 17 may be completely removed by one or more additional material-removing steps with the same or different tools.

When material removal is finished (FIG. 3c), the computer system still knows the history of material removal with the various area boundaries 16a, 17a, so that new material can be added in one or more iterative add-on steps in accordance with this material-removal history, for example by Laser Metal Forming (LMF), or the like. Turbine blade 10 finally comprises an area 18 of added material (FIG. 3d).

In summary, the present invention uses material detection inside a machine tool and an adaptive tool path generation, resulting in a material-based closed loop manufacturing process. This process allows a precise and fast reworking of a component (material removal and addition), which is
a pre-requisite for avoiding unnecessary or even detrimental material removal (e.g. by milling, etc.)
allowing for optimum bonding quality in material addition (e.g. by laser cladding, etc.)

### LIST OF REFERENCE NUMERALS

10 turbine blade
11 airfoil
12 platform
13 blade tip
14 leading edge
15 trailing edge
16,17,18 material area
16a,17a area boundary
19 component (to be machined, e.g. turbine blade)
20 multi-axis machine tool driven by an NC-controller
21 table
22 mounting foot
23 rail
24 cross beam
25 vertical carriage
26 tool holder
27 spectroscopy tool
28 spectroscopy beam
29 tool changer
30 machining tool
31 raster
32 raster point

1. Method for machining a component on a multi-axis machine tool driven by an NC-controller, comprising the steps of:
a) inserting said component into said machine tool;
b) fixing said component in said machine tool with a surface to be machined being reachable by a tool of said machine tool;
c) mapping a material composition on said surface of said inserted and fixed component by via a spectroscopy tool;
d) determine areas for removing material from or adding material to said component based on said mapped material composition;
e) determine a tool path for removing material from or adding material to said component; and
f) removing material from or adding material to said component in said determined areas along said determined tool path via said machine tool.

2. Method as claimed in claim 1, wherein a raster with a plurality of defined or arbitrary raster points is provided for said surface of said component to be machined, and that said material composition of said component is mapped at said raster points of said raster.

3. Method as claimed in claim 1, wherein said step of removing material from said component comprises one of grinding, milling, Electrical Discharge Machining, or other material-removing process.

4. Method as claimed in claim 1, wherein said step of adding material to said component comprises Laser Metal Forming, or other material-additive process.

5. Method as claimed in claim 2, wherein said raster with said plurality of raster points is defined on the basis of a CAD model of said component.

6. Method as claimed in claim 2, said raster with said plurality of raster points is based on a scan of a geometry of said component.

7. Method as claimed in claim 1, wherein steps (c) to (f) are rerun at least one time with a same or a different tool.

8. Method as claimed in claim 1, wherein said component is a part of a gas turbine.

9. Method as claimed in claim 8, wherein said component is a turbine blade.

10. Method as claimed in claim 1, wherein said spectroscopy tool is mounted in a fixed position inside said machine tool.

11. Method as claimed in claim 1, wherein said machine tool is equipped with a tool changer, and that said spectroscopy tool is provided in said tool changer of said machine tool.

12. Apparatus for conducting the method according to claim 1, comprising:
a multi-axis machine tool driven by an NC-controller with tools for removing material from or adding material to a component inserted into and fixed in said machine tool, wherein a spectroscopy tool is provided at said machine tool for mapping the material composition on a surface of said inserted and fixed component.

13. Apparatus as claimed in claim 12, wherein said spectroscopy tool is mounted in a fixed position inside said machine tool.

14. Apparatus as claimed in claim 12, wherein said machine tool is equipped with a tool changer, and that said spectroscopy tool is provided in said tool changer of said machine tool.
